(19) United States
(12) Patent Application Publication
(10) Pub. No.: US 2014/0100748 A1
(43) Pub. Date: Apr. 10, 2014

(54) System and Method for Controlling Hydraulic Pressure of Damper Clutch

(71) Applicant: HYUNDAI MOTOR COMPANY, Seoul (KR)

(72) Inventor: Youngmin KIM, Seoul (KR)

(73) Assignee: Hyundai Motor Company, Seoul (KR)

(21) Appl. No.: 13/714,165

(22) Filed: Dec. 13, 2012

(30) Foreign Application Priority Data
Oct. 5, 2012 (KR) 10-2012-0110930

(51) Int. Cl. B60W 10/02

(52) U.S. Cl. CPC B60W 10/023
USPC 701/68

(57) ABSTRACT

A method for controlling hydraulic pressure of a damper clutch may include determining a hydraulic pressure control mode of the damper clutch in accordance with vehicle driving conditions and a state of the damper clutch, determining a hydraulic pressure control value according to the hydraulic pressure control mode, determining target waveforms of engine rotation speed and turbine rotation speed according to the hydraulic pressure control mode, detecting a waveform of the engine rotation speed and a waveform of the turbine rotation speed, judging whether detected waveforms of the engine rotation speed and the turbine rotation speed correspond with the target waveforms thereof respectively, and, regulating the hydraulic pressure control value so as to make the detected waveforms of the engine rotation speed and the turbine rotation speed correspond with the target waveforms of the engine rotation speed and the turbine rotation speed respectively.

### CROSS-REFERENCE TO RELATED APPLICATION

The present application claims priority to Korean Patent Application No. 10-2012-110930 filed on Oct. 5, 2012, the entire contents of which is incorporated herein for all purposes by this reference.

### BACKGROUND OF THE INVENTION

1. Field of the Invention

The present invention relates to a system and method for controlling hydraulic pressure of a damper clutch.

2. Description of Related Art

In general, gear speed of an automatic transmission is changed automatically to a target speed by a transmission control device that controls hydraulic pressure by controlling a lot of solenoid valves according to an opening of throttle valve and several detecting conditions.

The automatic transmission has a torque converter which is mounted at between engine and transmission, and a damper clutch is installed inside the torque converter. The damper clutch may become slip, open, or lock-up by the controlling of operating hydraulic pressure.

A prior art sets a hydraulic pressure for controlling the damper clutch in accordance with each the transmission condition, and tests whether the damper clutch is controlled appropriately by driving and testing the vehicle actually. If it is judged that the damper clutch is not appropriately controlled since the hydraulic pressure applied to the damper clutch is larger than expected, then downgrading setting level of hydraulic pressure. On the contrary, if the hydraulic pressure applied to the damper clutch is smaller than expected, then upgrading setting level of hydraulic pressure. The prior art regulates the hydraulic pressure by repeating this process so as to make the damper clutch to be controlled appropriately in each transmission condition.

However, the prior art has a problem that it spends too much time and cost for setting hydraulic pressure of the damper clutch since said hydraulic pressure setting method which sets the hydraulic pressure by repeating actual test need to carry out said setting process for each transmission conditions. Further, control reliability is not high since the relation between control duty and actual discharging hydraulic pressure is not linear although the hydraulic pressure is set by the method of the prior art.

Further, the prior art has a problem of spending extra time and cost for carrying out the hydraulic pressure setting process from beginning to end whenever a control logic or hardware of the transmission management system changes.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a system and method for controlling hydraulic pressure of a damper clutch having advantages of reducing time and cost for controlling the damper clutch and improving control reliability simultaneously.

In an aspect of the present invention, a method for controlling hydraulic pressure of a damper clutch, may include determining a hydraulic pressure control mode of the damper clutch in accordance with vehicle driving conditions and a state of the damper clutch, determining a hydraulic pressure control value according to the hydraulic pressure control mode, determining a target waveform of engine rotation speed and a target waveform of turbine rotation speed according to the hydraulic pressure control mode, detecting a waveform of the engine rotation speed and a waveform of the turbine rotation speed, judging whether a detected waveform of the engine rotation speed and a detected waveform of the turbine rotation speed correspond with the target waveform of the engine rotation speed and the target wave form of the turbine rotation speed respectively, and, regulating the hydraulic pressure control value so as to make the detected waveform of the engine rotation speed and the detected waveform of the turbine rotation speed correspond with the target waveform of the engine rotation speed and the target wave form of the turbine rotation speed respectively.

The hydraulic pressure control value is regulated to increase in the regulating the hydraulic pressure control value when deviation between the detected waveforms of the engine rotation speed and the turbine rotation speed is larger than the deviation between the target waveforms of the engine rotation speed and turbine rotation speed.

The hydraulic pressure control value is regulated to decrease in the regulating the hydraulic pressure control value when the deviation between the detected waveform of the engine rotation speed and the turbine rotation speed is smaller than the deviation between target waveform of the engine rotation speed and turbine rotation speed.

The method may include carrying out hydraulic pressure control when detected waveforms of the engine rotation speed and the turbine rotation speed corresponds with target waveforms of the engine rotation speed and the turbine rotation speed respectively.

The hydraulic pressure control value is determined from a hydraulic pressure control logic which is predetermined to each hydraulic pressure control mode.

In another aspect of the present invention, a system for controlling hydraulic pressure of a damper clutch, may include an engine data detecting portion which detects data including an engine rotation speed and a turbine rotation speed required to control an engine, a transmission data detecting portion which detects data including a state of the damper clutch required to control a transmission, and, a control portion which controls hydraulic pressure of the damper clutch based on the data of the engine data detecting portion and the data of the transmission data detecting portion wherein the control portion controls the hydraulic pressure of the damper clutch according to the method.

The control portion is a transmission management system (TMS).

The system may further include a hydraulic pressure regulating portion which regulates the hydraulic pressure of the damper clutch by receiving a control signal from the control portion.

The hydraulic pressure regulating portion is a solenoid valve.

The system and method for controlling hydraulic pressure of a damper clutch according to an exemplary embodiment of the present invention have advantages of reducing time and cost for controlling the damper clutch and controlling the damper clutch with speediness and correctness.

Further, the present invention provides work convenience since there is no need to doing additional hydraulic pressure setting process for the damper clutch although a control logic or hardware of the transmission control system changes.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of a system for controlling hydraulic pressure of a damper clutch according to an exemplary embodiment of the present invention.

FIG. 2 is a flowchart of a method for controlling hydraulic pressure of a damper clutch according to an exemplary embodiment of the present invention.

FIG. 3 is a schematic diagram of a method for controlling hydraulic pressure of a damper clutch.

It should he understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to accompanying drawings.

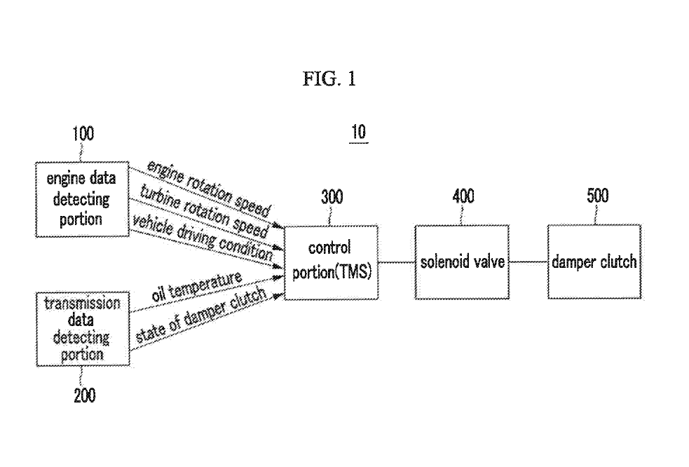

FIG. 1 is a block diagram of a system 10 for controlling hydraulic pressure of a damper clutch according to an exemplary embodiment of the present invention.

Referring to FIG. 1, the system for controlling hydraulic pressure according to an exemplary embodiment of the present invention may include an engine data detecting portion 100, a transmission data detecting portion 200, a control portion 300, and a hydraulic pressure regulating portion 400.

The engine data detecting portion 100 detects all of the information required to control engine and vehicle such as vehicle speed, crank angle, engine rotation speed, turbine rotation speed, temperature of cooling water, and opening of throttle valve.

In some exemplary embodiments, the engine data detecting portion 100 may include a lot of sensors such as a vehicle speed sensor, a crank sensor, an engine rotation speed sensor, a turbine rotation speed sensor, a coolant temperature sensor, and a throttle valve opening sensor. And the engine data detecting portion 100 may detect the vehicle speed, the crank angle, the engine rotation speed, turbine rotation speed, the temperature of the cooling water, the opening of the throttle valve using these sensors.

The transmission data detecting portion 200 detects all of the information required to control a transmission such as an oil temperature, rotation speeds of input and output shaft, and a state of the damper clutch.

In some of exemplary embodiments, the transmission data detecting portion 200 may include an oil temperature sensor, rotation speed sensors of input and output shaft, and a damper clutch sensor. And the transmission data detecting portion 200 may detect the oil temperature, the rotation speeds of input and output shaft, and the state of the damper clutch using these sensors.

The control portion 300 controls hydraulic pressure of the damper clutch 500 based on the information such as the engine rotation speed, the turbine rotation speed, a driving condition of the vehicle, and the state of the damper clutch transmitted from the engine data detecting portion 100 and the transmission data detecting portion 200.

The control portion 300 may include at least one processor which is operated by a predetermined program. And the predetermined program may be programmed to carry out each step of the method for controlling hydraulic pressure of a damper clutch.

In some exemplary embodiments, the control portion 300 may be a transmission management system (TMS).

The transmission management system (TMS) refers to a system for carrying out optimal gear shift by control commands which are programmed based on the transmission information so as to control an automatic transmission of a vehicle.

The hydraulic pressure regulating portion 400 is connected to the damper clutch 500 and controls hydraulic pressure of the damper clutch 500 by receiving hydraulic pressure control signal from the control portion.

In some exemplary embodiments, the hydraulic pressure regulating portion 400 may be an actuator or a solenoid valve operating electronically.

A method for controlling hydraulic pressure of the damper clutch will be described in detail with reference to accompanying drawings.

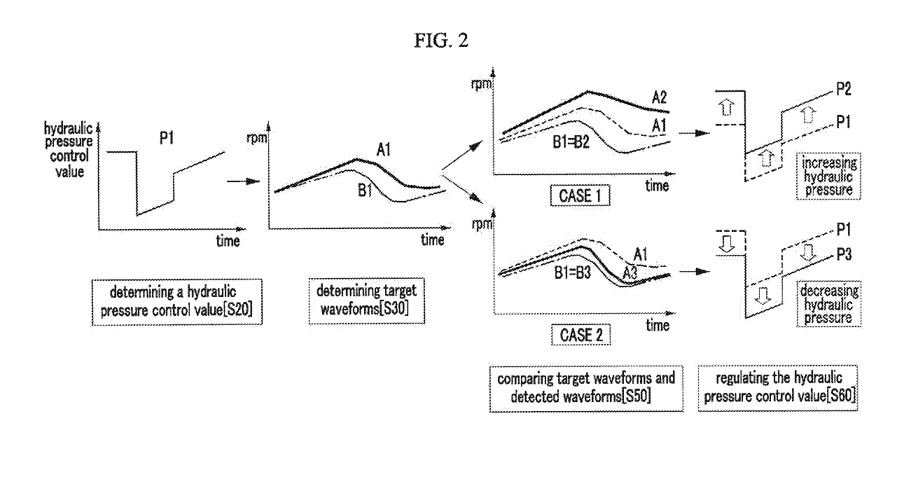

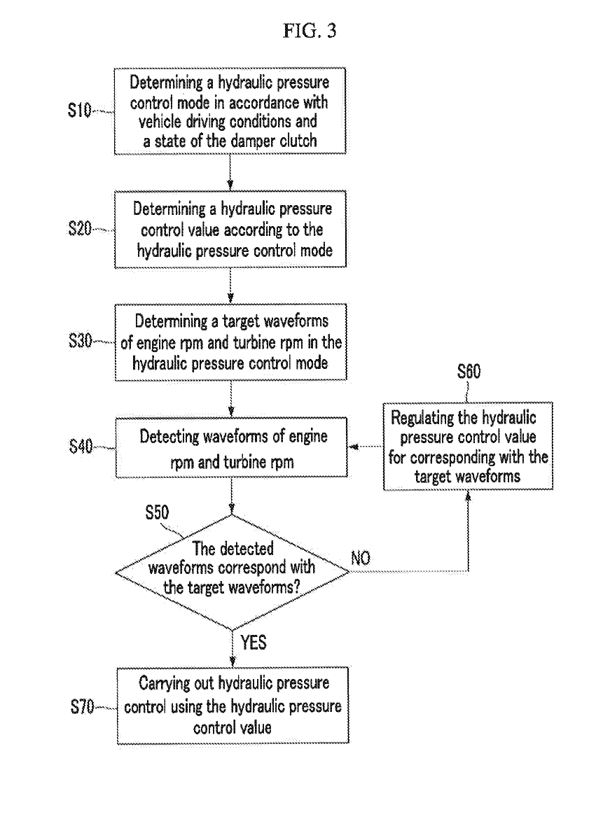

FIG. 2 is a flowchart of the method for controlling hydraulic pressure of a damper clutch according to an exemplary embodiment of the present invention, and FIG. 3 is a schematic diagram of the method for controlling hydraulic pressure of a damper clutch.

Referring FIG. 2 to FIG. 3, the control portion 300 determines a hydraulic pressure control mode of the damper clutch in accordance with vehicle driving conditions transferred from the engine data detecting portion 100 and a state of the damper clutch transferred from the transmission data detecting portion 200 at step S10.

The vehicle driving condition stands for current driving state information of a vehicle such as a vehicle is in a cruise control state or an acceleration state.

The state of damper clutch stands for a state that represents whether the damper clutch is in a lock-up state, an open state, or a slip state. The slip state may be sorted into many states according to the slip level of the damper clutch.

The damper clutch control mode may refer to a types or a means for controlling the damper clutch. The damper clutch control mode may be set differently according to the driving condition of a vehicle and the state of automatic transmission such as the automatic transmission is in upshift state or down shift state. The damper clutch control mode may be set in advance in the program of the control portion 300 according to the state of damper clutch and the driving condition of the vehicle.

At step S20, the control portion 300 determines a hydraulic pressure control value according to the hydraulic pressure control mode which is determined at the step S10. The hydraulic pressure control value may be represented as a value that changes over time as shown in FIG. 2.

In some exemplary embodiments, the hydraulic pressure control value may be determined from a hydraulic pressure control logic which is stored in the control portion 300 in advance. In general, the hydraulic pressure control logic is predetermined to the each hydraulic pressure control mode and is stored in the transmission management system 300. Therefore, the control portion 300 may control the hydraulic pressure of the damper clutch by determining the hydraulic pressure control value using the hydraulic pressure control logic.

At step S30, and then, the control portion determines a target waveform A1 of engine rotation speed and a target waveform B1 of turbine rotation speed according to the hydraulic pressure control mode which is determined at the step S10.

The waveform of engine rotation speed represents a target engine rotation speed aimed at the control portion 300 over time in each hydraulic pressure control mode. The waveform A1 of engine rotation speed may be represented as shown in FIG. 2.

The waveform of turbine rotation speed represents a target turbine rotation speed aimed at the control portion 300 over time in each hydraulic pressure control mode. The waveform B1 of turbine rotation speed may be represented as shown in FIG. 2.

The target waveform A1 of engine rotation speed and the target waveform B1 of turbine rotation speed according to each the hydraulic pressure control mode may be predetermined and is stored at the program of the control portion 300.

At step S40, the control portion 300 detects a waveform A2 of engine rotation speed and a waveform 132 of turbine rotation speed currently.

The engine rotation speed and the turbine rotation speed may be measured by the engine rotation speed sensor and the turbine rotation speed sensor of the engine data detecting portion 100 respectively and may be transferred to the control portion 300 in real time. The control portion 300 may detect the waveform A2 of engine rotation speed and a waveform 132 of turbine rotation speed respectively by receiving the engine rotation speed and the turbine rotation speed from the engine data detecting portion 100 and drawing in order the engine rotation speed and the turbine rotation speed over time respectively.

At step S50, and then, the control portion 300 judges whether the waveform A2 of engine rotation speed and the waveform B2 of turbine rotation speed detected at the step S40 corresponds with the target waveform A1 of engine rotation speed and the target wave form B2 of turbine rotation speed.

At step S60, the control portion 300 regulates the hydraulic pressure control value P1 so as to make the detected waveforms A2 and B2 of engine rotation speed and turbine rotation speed to correspond with the target waveforms A1 and B1 of engine rotation speed and turbine rotation speed if the control portion 300 judged that the detected waveforms A2 and B2 of engine rotation speed and turbine rotation speed does not corresponds with the target waveforms A1 and B1 of engine rotation speed and turbine rotation speed.

The control portion 300 carries out the step S40 again after controlling hydraulic pressure of the damper clutch using the regulated the hydraulic pressure control value of the step S60. Therefore, the control portion 300 redetects the waveforms A2 and B2 of engine and turbine rotation speed at step S40, redetermines whether the waveforms A2 and B2 of engine and turbine rotation speed corresponds to the target waveforms A1 and B1 of engine and turbine rotation speed at step S50, and regulates again the hydraulic pressure control value if the redetected waveforms A2 and B2 does not corresponds to the target waveforms A1 and B1. It can be possible to find proper hydraulic pressure control value by repeating the above steps again at the control portion 300, and quickly match the waveforms A2 and B2 of engine and turbine rotation speed with the target waveforms A1 and B1 of engine and turbine rotation speed.

In some exemplary embodiments, the CASE 1 of FIG. 2 represents that the detected waveform B2 of turbine rotation speed corresponds with the target waveform B1 of turbine rotation speed, but the detected waveform A2 of engine rotation speed is larger than the target waveform A1 of engine rotation speed.

As shown in the CASE 1, the control portion 300 may increase the hydraulic pressure control value from P1 to P2 when the deviation between the detected waveform A2 of engine rotation speed and the waveform B2 of turbine rotation speed is larger than the deviation between target waveform A1 of the engine rotation speed and the target waveform B1 of turbine rotation speed. The control portion 300 matches the detected waveforms A2 and B2 with the target waveforms A1 and B1 by decreasing a slip rate represented as engine rotation speed minus turbine rotation speed by increasing the hydraulic pressure control value because the slip rate is larger than target value in the CASE 1.

In some exemplary embodiments, the CASE 2 of FIG. 2 represents that the detected waveform B3 of turbine rotation speed corresponds with the target waveform B1 of turbine rotation speed, but the detected waveform A3 of engine rotation speed is larger than the target waveform A1 of engine rotation speed.

As shown in the CASE 2, the control portion 300 may decrease the hydraulic pressure control value from P1 to P2 when the deviation between the detected waveform A3 of engine rotation speed and the waveform B3 of turbine rotation speed is smaller than the deviation between target waveform A1 of the engine rotation speed and the target waveform B1 of turbine rotation speed. The control portion 300 matches the detected waveforms A3 and B3 with the target waveforms A1 and B1 by increasing slip rate represented as engine rotation speed minus turbine rotation speed by decreasing the hydraulic pressure control value from P1 to P3 because the slip rate is larger than target value in the CASE 2.

At step S70, meanwhile, the control portion 300 carries out hydraulic pressure control by using the same hydraulic pressure control value if the control portion 300 judged that the detected waveforms A2 and B2 of engine rotation speed and turbine rotation speed corresponds with the target waveforms A1 and B1 of engine rotation speed and turbine rotation speed.

In some exemplary embodiments, the control portion 300 may control the hydraulic pressure of the damper clutch 500 by controlling the solenoid valve 400 through sending a hydraulic pressure control signal.

The method for controlling hydraulic pressure of a damper clutch according to an exemplary embodiment of the present invention can control hydraulic pressure of the damper clutch with speed and accuracy by determining target waveforms of engine and turbine rotation speed each hydraulic pressure control mode, comparing the target waveforms of engine and turbine rotation speed with detected waveforms of engine and turbine rotation speed, and regulating the hydraulic pressure so that the detected waveforms follows the target waveforms. Therefore, the time and cost for controlling hydraulic pressure of the damper clutch can be reduced according to an exemplary embodiment of the present invention.

Further, the present invention can improve convenience for controlling hydraulic pressure of the damper clutch, since controlling hydraulic pressure to follow the target waveforms of engine and turbine rotation speed is the same even if a hardware or a control logic of a transmission management system.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the an to make and utilize various exemplary embodiments of the present invention, as well as various alternatives and modifications thereof. It is intended that the scope of the invention be defined by the Claims appended hereto and their equivalents.

What is claimed is:

1. A method for controlling hydraulic pressure of a damper clutch, comprising:
determining a hydraulic pressure control mode of the damper clutch in accordance with vehicle driving conditions and a state of the damper clutch;
determining a hydraulic pressure control value according to the hydraulic pressure control mode;
determining a target waveform of engine rotation speed and a target waveform of turbine rotation speed according to the hydraulic pressure control mode;
detecting a waveform of the engine rotation speed and a waveform of the turbine rotation speed;
judging whether a detected waveform of the engine rotation speed and a detected waveform of the turbine rotation speed correspond with the target waveform of the engine rotation speed and the target wave form of the turbine rotation speed respectively; and,
regulating the hydraulic pressure control value so as to make the detected waveform of the engine rotation speed and the detected waveform of the turbine rotation speed correspond with the target waveform of the engine rotation speed and the target wave form of the turbine rotation speed respectively.

2. The method of claim 1, wherein the hydraulic pressure control value is regulated to increase in the regulating the hydraulic pressure control value when deviation between the detected waveforms of the engine rotation speed and the turbine rotation speed is larger than the deviation between the target waveforms of the engine rotation speed and turbine rotation speed.

3. The method of claim 1, wherein the hydraulic pressure control value is regulated to decrease in the regulating the hydraulic pressure control value when the deviation between the detected waveform of the engine rotation speed and the turbine rotation speed is smaller than the deviation between target waveform of the engine rotation speed and turbine rotation speed.

4. The method of claim 1, further including carrying out hydraulic pressure control when detected waveforms of the engine rotation speed and the turbine rotation speed corresponds with target waveforms of the engine rotation speed and the turbine rotation speed respectively.

5. The method of claim 1, wherein the hydraulic pressure control value is determined from a hydraulic pressure control logic which is predetermined to each hydraulic pressure control mode.

6. A system for controlling hydraulic pressure of a damper clutch, comprising:
an engine data detecting portion which detects data including an engine rotation speed and a turbine rotation speed required to control an engine;
a transmission data detecting portion which detects data including a state of the damper clutch required to control a transmission; and,
a control portion which controls hydraulic pressure of the damper clutch based on the data of the engine data detecting portion and the data of the transmission data detecting portion:
wherein the control portion controls the hydraulic pressure of the damper clutch according to the method of claim 1.

7. The system of claim 6, wherein the control portion is a transmission management system (TMS).

8. The system of claim 6, further including a hydraulic pressure regulating portion which regulates the hydraulic pressure of the damper clutch by receiving a control signal from the control portion.

9. The system of claim 7, wherein the hydraulic pressure regulating portion is a solenoid valve.
